(19) United States
(12) Patent Application Publication
(10) Pub. No.: US 2023/0346618 A1
(43) Pub. Date: Nov. 2, 2023

(54) SYSTEM FOR APPLYING THERAPY TO A HUMAN BODY

(71) Applicant: Rensselaer Polytechnic Institute, Troy, NY (US)

(72) Inventors: Eric H. Ledet, Schenectady, NY (US); Michael Castello, Pearl River, NY (US); Ryan Chien, Kinnelon, NJ (US); Jeongwon Choi, Lexington, MA (US); Ruiqi Ma, Shanghai (CN); Jacqueline Ray, Cumberland, RI (US)

(73) Assignee: Rensselaer Polytechnic Institute, Troy, NY (US)

(21) Appl. No.: 18/140,736

(22) Filed: Apr. 28, 2023

Related U.S. Application Data
(60) Provisional application No. 63/335,956, filed on Apr. 28, 2022.

(51) Int. Cl. A61G 7/10; A61G 15/02

(52) U.S. Cl. CPC A61G 7/1059; A61G 15/02; A61G 2200/34

(57) ABSTRACT

In one embodiment, there is provided a system for applying therapy to a human body. The system includes a coupling apparatus and a supporting apparatus. The coupling apparatus is configured to couple to an upper body portion of a user. The supporting apparatus is configured to support at least a portion of a weight of the user. An amount of weight that is supported is adjustable. In some embodiments, the system may further include a control apparatus configured to control at least one of a state and/or a position of the supporting apparatus.

### CROSS REFERENCE TO RELATED APPLICATION(S)

This application claims the benefit of U.S. Provisional Application No. 63/335,956, filed Apr. 28, 2022, which is incorporated by reference as if disclosed herein in its entirety.

### FIELD

The present disclosure relates to a system for applying therapy, in particular to, a system for applying therapy to a human body.

### BACKGROUND

Low back pain is a common problem affecting approximately 90% of adults in the United States at some point in their lives. Etiologies are related primarily to various musculoskeletal problems, mostly muscle strain and degenerative disease of the vertebral joints. Therapy may include analgesic medications, a balanced rest program, exercises, physical therapy, and ergonomic counseling. Alternative therapies may include various forms of manipulation, massage, injections, traction, percutaneous electrical nerve stimulation, acupuncture, and other techniques. In some cases, surgical intervention may be performed in order to reduce pressure on nerves or the spinal cord.

Mechanized spinal distraction devices may utilize computer controlled mechanical tables to apply distractive tension, or stretching, along the spinal axis. The distractive tension may be applied cyclically and over a period of time on the order of tens of minutes and/or ones of hours. Applied distraction along the spinal axis is configured to reduce pressure in the intervertebral discs and/or intervertebral joint spaces to help relieve back pain. Applied distraction may provide nonoperative treatment options for the relief of back pain associated with disc protrusion, disc herniation, degenerative disc disease, facet syndrome, or radiculopathy. Generally, during treatment, a user lays on the table and is thus limited in both position and activity.

### SUMMARY

In some embodiments, there is provided a system for applying therapy to a human body. The system includes a coupling apparatus and a supporting apparatus. The coupling apparatus is configured to couple to an upper body portion of a user. The supporting apparatus is configured to support at least a portion of a weight of the user. An amount of weight that is supported is adjustable. In some embodiments, the system may further include a control apparatus configured to control at least one of a state and/or a position of the supporting apparatus.

In some embodiments, the system further includes a control apparatus configured to control at least one of a state and/or a position of the supporting apparatus.

In some embodiments of the system, the coupling apparatus is selected from the group including a vest, a belt, a harness, one or more straps, a hook portion and/or a loop portion of a hook and loop assembly, and/or a combination thereof.

In some embodiments of the system, the supporting apparatus is selected from the group including a chair, a chair back, a seat, a seat pan, a harness, and/or a combination thereof.

In some embodiments of the system, the therapy is configured to be applied when the user is in a sitting position.

In some embodiments of the system, the coupling apparatus and the supporting apparatus are configured to facilitate applying traction to at least a portion of a spine of the user.

In some embodiments of the system, the supporting apparatus is configured to support a first portion of the weight of the user and the coupling apparatus is configured to support a second portion of the weight of the user.

In some embodiments of the system, the coupling apparatus and the supporting apparatus are a same apparatus.

In some embodiments of the system, the coupling apparatus includes an adjustable feature configured to enhance user comfort.

In some embodiments of the system, the control apparatus is further configured to control a state of the coupling apparatus.

In some embodiments, there is provided a method for applying therapy to a human body. The method includes coupling, by a coupling apparatus, to an upper body portion of a user. The method further includes supporting, by a supporting apparatus, at least a portion of a weight of the user. An amount of weight that is supported is adjustable.

In some embodiments, the method further includes controlling, by a control apparatus, at least one of a state and/or a position of the supporting apparatus.

In some embodiments of the method, the coupling apparatus is selected from the group including a vest, a belt, a harness, one or more straps, a hook portion and/or a loop portion of a hook and loop assembly, and/or a combination thereof.

In some embodiments of the method, the supporting apparatus is selected from the group including a chair, a chair back, a seat, a seat pan, a harness, and/or a combination thereof.

In some embodiments of the method, the therapy is applied when the user is in a sitting position.

In some embodiments of the method, the coupling apparatus and the supporting apparatus are configured to facilitate applying traction to at least a portion of a spine of the user.

In some embodiments of the method, the supporting apparatus is configured to support a first portion of the weight of the user, and further including supporting, by the coupling apparatus, a second portion of the weight of the user.

In some embodiments of the method, the coupling apparatus and the supporting apparatus are a same apparatus.

In some embodiments, the method further includes enhancing, by an adjustable feature, user comfort.

In some embodiments, the method further includes controlling, by the control apparatus, a state of the coupling apparatus.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1A illustrates a functional block diagram of a system for applying therapy to a human body (“therapy system”), according to several embodiments of the present disclosure;

FIG. 1B illustrates a functional block diagram of a therapy management apparatus corresponding to one example of the control apparatus of FIG. 1A;

FIGS. 2A through 2C are sketches illustrating an office chair that includes one example of a system for applying therapy to a human body, according to one embodiment of the present disclosure;

FIG. 3 is a sketch illustrating an office chair that includes another example of a portion of a system for applying therapy to a human body, according to one embodiment of the present disclosure;

FIG. 4 is a sketch illustrating an office chair that includes another example system for applying therapy to a human body, according to one embodiment of the present disclosure;

FIG. 5 is a sketch illustrating an office chair that includes another example system for applying therapy to a human body, according to one embodiment of the present disclosure;

FIG. 6 is a sketch illustrating an office chair that includes another example system for applying therapy to a human body, according to one embodiment of the present disclosure; and

FIGS. 7A and 7B are sketches illustrating example adjustable features for enhancing user comfort for a coupling apparatus for a system for applying therapy to a human body, according to several embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a system for applying therapy to a human body (“therapy system”). Therapy may include, for example, spinal decompression. Spinal decompression is configured to relieve pressure on a spine of a user, and may include applying distractive tension. In some embodiments, the therapy may be applied while the user is in a sitting position, e.g., while sitting in a chair, and may be configured to apply a pulling force (i.e., tension). In some embodiments, the therapy may be applied while a user is at least partially suspended and may be configured to use gravity to apply the therapy.

In one embodiment, there is provided a system for applying therapy to a human body. The system includes a coupling apparatus and a supporting apparatus. The coupling apparatus is configured to couple to an upper body portion of a user. The supporting apparatus is configured to support at least a portion of a weight of the user. An amount of weight that is supported is adjustable. In some embodiments, the system may further include a control apparatus configured to control at least one of a state and/or a position of the supporting apparatus.

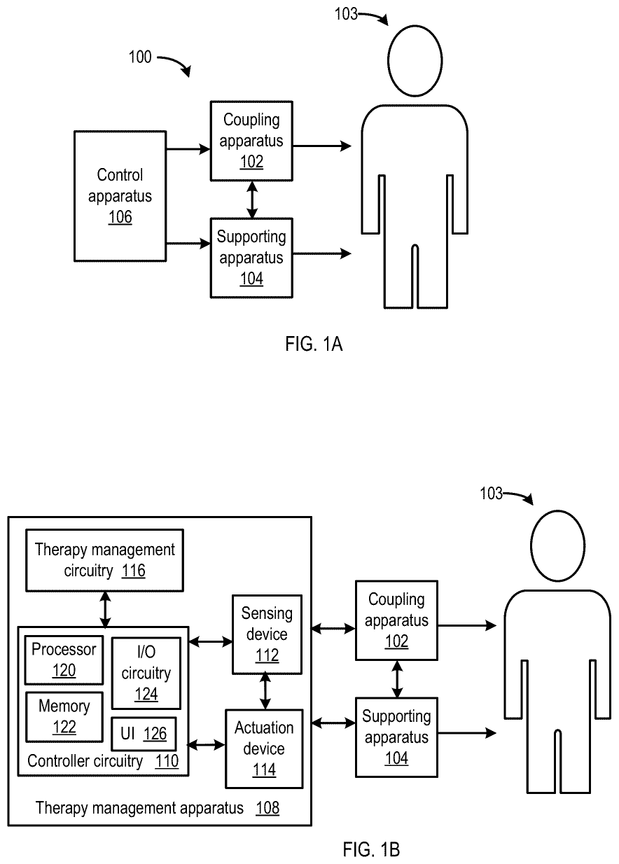

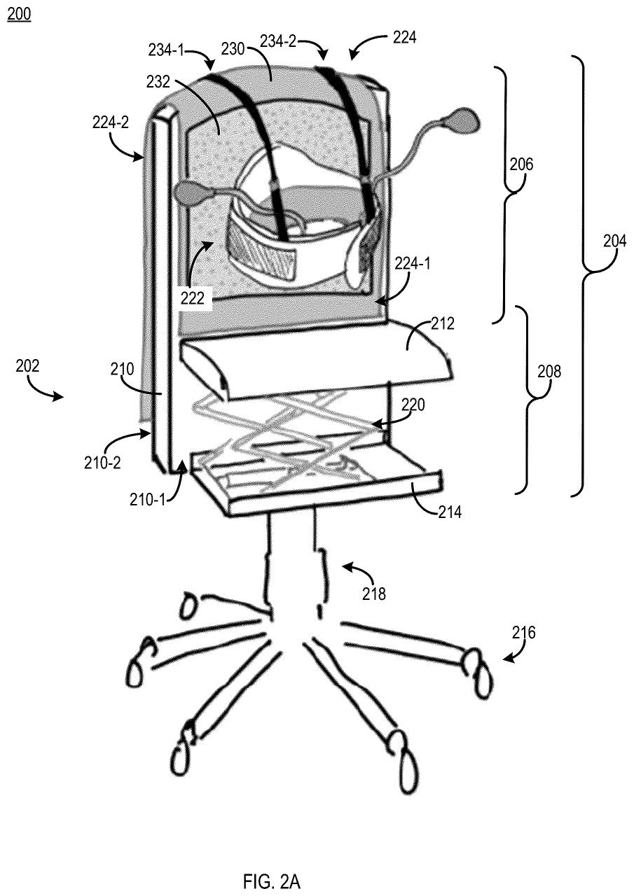

FIG. 1A illustrates a functional block diagram of a system 100 for applying therapy to a human body (“therapy system”), according to several embodiments of the present disclosure. Therapy system 100 includes a coupling apparatus 102, and a supporting apparatus 104, and may include a control apparatus 106.

The coupling apparatus 102 is configured to couple to an upper body portion of a user 103. Upper body portion may generally include a portion of the human body at and/or above a user's hips. Upper body portion may include, but is not limited to, torso, upper back, shoulders, etc. The coupling apparatus 102 may include, but is not limited to, a vest, a belt, a harness, one or more straps, a hook portion and/or a loop portion of a hook and loop assembly, and/or a combination thereof. The supporting apparatus 104 is configured to support at least a portion of the weight of the user 103. In an embodiment, an amount of weight that is supported may be adjustable. The supporting apparatus 104 may thus include a chair (e.g., an office chair, a recliner, a straight chair, etc.), a chair back, a seat, a seat pan, a harness, and/or a combination thereof, etc. In some embodiments, the coupling apparatus 102 and the supporting apparatus 104 may be a same apparatus. In some embodiments, at least a portion of the coupling apparatus 102 may correspond to at least a portion of the supporting apparatus 104.

The control apparatus 106 is configured to control at least one of a state and/or a position of the supporting apparatus 104. In some embodiments, the control apparatus 106 may be controlled by the user 103 based, at least in part, on one or more of user preference, user comfort, an amount of time in a position, a user characteristic (e.g., user age, user weight, user height, etc.), etc. In some embodiments, the control apparatus 106 may be configured to control a state and/or a position of the coupling apparatus 102. As used herein, “control a state and/or a position” corresponds to adjusting and/or maintaining the state and/or position of the supporting apparatus 104 and/or the coupling apparatus 102. In some embodiments, the control apparatus 106 may correspond to a therapy management apparatus 108, as will be described in more detail below. In some embodiments, the control apparatus 106 may correspond to a control mechanism. A control mechanism may include, but is not limited to, a mechanical actuator that may be adjusted by a user via a user input device. The mechanical actuator may include, but is not limited to, a solenoid, a rack and pinion, a lead screw, a screw jack, a hydraulic jack, a linear actuator, a scissor lift, a pneumatic bladder, a pneumatic cylinder, a hydraulic cylinder, a motor, a pneumatic pump, a hydraulic pump, etc. The user input device may include, but is not limited to, a control knob, a control lever, a pneumatic ball, an electrical switch, a push button, etc. Selection of a control mechanism may be based, at least in part, on characteristics of the selected coupling apparatus 102 and/or supporting apparatus 104, as described herein. For example, a rack in a rack and pinion assembly may be coupled to a supporting apparatus and turning a control knob coupled to the pinion may to adjust a linear position of the supporting apparatus. However, this disclosure is not limited in this regard.

FIG. 1B illustrates a functional block diagram of a therapy management apparatus 108 corresponding to one example of the control apparatus 106 of FIG. 1A. Therapy management apparatus 108 is another example of a control apparatus, according to the present disclosure. Therapy management apparatus 108 may be configured to provide, for example, automated and/or closed loop control of coupling apparatus 102 and/or supporting apparatus 104. Therapy management apparatus 108 includes controller circuitry 110, a sensing device 112, an actuation device 114, and therapy management circuitry 116.

Controller circuitry 110 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Sensing device 112 may be configured to sense a pressure, a force, and/or a position related to the coupling apparatus 102 and/or the supporting apparatus 104. Actuation device 114 may be configured to adjust a pressure, a force and/or a position related to the coupling apparatus 102 and/or the supporting apparatus 104. Sensing device 112 may include, but is not limited to, a pressure sensor, a force sensor, a strain gauge, etc. Actuation device 114 may include, but is not limited to, a solenoid, a rack and pinion, a lead screw, a screw jack, a linear actuator, a pneumatic cylinder, a hydraulic cylinder, a motor, etc.

Controller circuitry 110 includes a processor 120, a memory 122, input/output (I/O) circuitry 124, and a user interface (UI) 126. Processor 120 is configured to perform operations of therapy management circuitry 116. Memory 122 may be configured to store data associated with sensing device 112, actuation device 114, and/or therapy management circuitry 116. I/O circuitry 124 may be configured to provide wired and/or wireless communication functionality for therapy management apparatus 108. UI 126 may include an electronic user input device (e.g., keyboard, mouse, microphone, touch sensitive display, etc.) and/or an electronic user output device, e.g., a display.

In some embodiments, therapy management circuitry 116 may be configured to receive user input(s) via UI 126, and to control the coupling apparatus 102 and/or the supporting apparatus 104 based, at least in part, on the user input(s). In closed loop control, for example, the actuation device 114 may be controlled based, at least in part, on sensed data from sensing device 112. Sensing device 112 may be configured to sense, for example, a position of a rack of a rack and pinion. The therapy management circuitry 116 may be configured to compare the sensed position to a target position and to adjust (e.g., turn the pinion) to move the rack to the target position. In some embodiments, the target position may be set by the user. The adjusting may be achieved by the actuation device 114 configured to turn the pinion. Thus, therapy management apparatus 108 may be configured to automate control of a state and/or position of the supporting apparatus 104, and may be further configured to automate control of a state and/or position of the coupling apparatus 102. It may be appreciated that comfort of the user 103, and/or an amount of weight supported, may thus be adjusted.

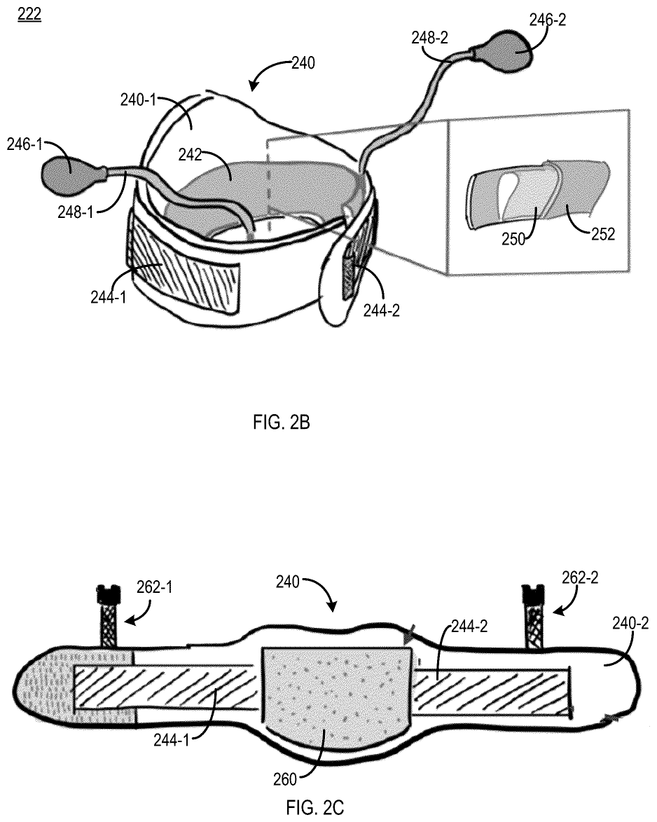

FIGS. 2A through 2C are sketches illustrating an office chair that includes one example of a system for applying therapy to a human body, according to one embodiment of the present disclosure. FIG. 2A is a sketch 200 that includes an office chair 202 and an example therapy system 204 for applying therapy to a human body. The office chair 202 includes a chair back 210, a chair seat 212, a seat base 214, a chair base 216, and a seat base height adjustment element (e.g., a pneumatic cylinder) 218. The chair back 210 is coupled to the seat base 214. The seat base 214 is coupled to the chair base 216 by the seat base height adjustment element 218.

The example therapy system 204 includes a coupling apparatus 206, a supporting apparatus 208, and a control apparatus 220. The coupling apparatus 206 includes a user coupling structure 222, and a support coupling structure 224. The user coupling structure 222 generally corresponds to a belt assembly configured to wrap around a torso of the user at or near a waist region of the user. The support coupling structure 224 is generally configured to be placed over the chair back 210 with a front section 224-1 positioned on a front surface 210-1 of the chair back and a back section 224-2 positioned adjacent a back surface 210-2 of the chair back. The support coupling structure 224 includes a compliant base portion 230, e.g., a fabric, that includes the front section 224-1 and the back section 224-2 and a coupling region 232 that covers at least a portion of the front section 224-1 of the support coupling structure 224. In some embodiments, the support coupling structure 224 may further include one or more attachment features, e.g., straps 234-1, 234-2, configured to detachably couple the user coupling structure 222 to the support coupling structure 224 and/or the chair back 210.

In one nonlimiting example, the user coupling structure 222 may include the hook or loop portion of a hook and loop assembly positioned on an outer surface of the user coupling structure 222 and the support coupling structure 224 may include the mating loop or hook portion positioned on the front surface 210-1 of the chair back. Continuing with this example, when the user is sitting in the chair 202, the user coupling portion 222 is configured to detachably couple to the support coupling portion 224.

In operation, the control apparatus 220 is configured to adjust a position of the chair seat 212 relative to the seat base 214. In one nonlimiting example, the control apparatus 220 may correspond to a scissor lift. However, this disclosure is not limited in this regard. Adjusting the position of the chair seat 212 relative to the seat base 214 may operate to similarly adjust a position of the chair seat 212 relative to the chair back 210 and thus relative to the coupling apparatus 206. It may be appreciated that such adjustment may be configured to provide a variable amount of traction (e.g., distraction tension) to a user's spine. In other words, as the chair seat 212 is lowered, a relatively smaller portion of the user's weight may be supported by the supporting apparatus 208 while the user's upper body is coupled to the coupling structure 224, providing spinal decompression using gravity and the user's weight.

FIG. 2B is a detail view of the user coupling structure 222 of FIG. 2A. The user coupling structure 222 corresponds to a harness in this example. However, this disclosure is not limited in this regard. In other examples, the user coupling structure may correspond to a vest, a belt, a strap, etc. The user coupling structure 222 includes a belt 240 and an adjustable feature 242. The adjustable feature 242 may be positioned on an inner surface 240-1 of the belt 240. The adjustable feature 242 in this example includes a compliant inflatable pneumatic tube 250 surrounded by a layer 252 of compliant material, e.g., foam rubber. The compliant material layer 252 may be configured to enhance user comfort and to reduce movement of the user coupling structure 222 relative to the user. The pneumatic tube 250 is coupled to at least one hand pump, e.g., pneumatic bulbs 246-1, 246-2, by at least one respective pneumatic hose, e.g., pneumatic hoses 248-1, 248-2. An amount of pressure in the pneumatic tube 250 and thus an amount of compressive force applied to the user may be adjusted by inflating or deflating the pneumatic tube using the pneumatic bulbs. In some embodiments, the user coupling structure 222 may include a plurality of pneumatic tubes.

FIG. 2C is a detail view of an outer surface 240-2 of the belt 240 of FIG. 2B. The belt 240 includes an adjustable feature, e.g., compliant regions 244-1, 244-2, configured to provide adjustable elastic tension to the belt 240. The adjustable elastic tension is configured to enhance user comfort and to accommodate a variety of users, e.g., a variety of user waist sizes. The belt 240 includes a belt coupling region 260 configured to couple to the coupling region 232 of the coupling structure 224. For example, the belt coupling region may include the hook or loop portion of the hook and loop assembly, as described herein. In this example, the belt 240 may further include one or more attachment features, e.g., straps 262-1, 262-2, configured to detachably couple the belt 240 to attachment features, e.g., straps 234-1, 234-2, and the support coupling structure 224 and/or the chair back 210. The attachment features may be configured to enhance user comfort and/or coupling of the user coupling structure to the support coupling structure, as described herein.

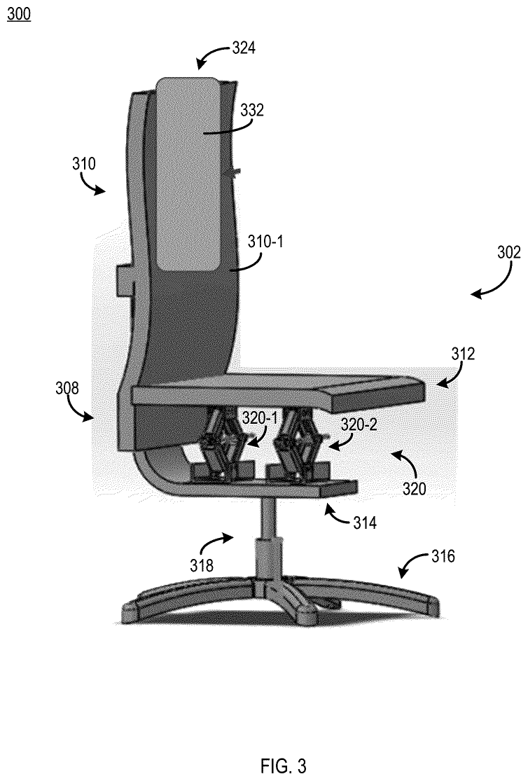

FIG. 3 is a sketch 300 illustrating an office chair 302 that includes another example of a portion of a system for applying therapy to a human body, according to one embodiment of the present disclosure. The office chair 302 includes a chair back 310, a chair seat 312, a seat base 314, a chair base 316, and a seat base height adjustment element 318. The chair back 310 is coupled to the seat base 314. The seat base 314 is coupled to the chair base 316 by the seat base height adjustment element 318.

The portion of the example therapy system includes a portion of a coupling apparatus, a supporting apparatus 308, and a control apparatus 320. The coupling apparatus portion includes a support coupling structure 324. The support coupling structure 324 is positioned on a front surface 310-1 of the chair back. The support coupling structure 324 includes a coupling region 332. In one nonlimiting example, the coupling region 332 may include the hook or loop portion of a hook and loop assembly positioned on the front surface 310-1 of the chair back. Continuing with this example, when the user is sitting in the chair 302, the user coupling portion is configured to detachably couple to the support coupling portion 324, as described herein.

In operation, the control apparatus 320 is configured to adjust a position of the chair seat 312 relative to the seat base 314. In this example 300, the control apparatus 320 includes a plurality of scissor lifts, e.g., scissor lifts 320-1, 320-2. The scissor lifts are positioned between the chair seat 312 and the seat base 314. Adjusting the position of the chair seat 312 relative to the seat base 314 may operate to similarly adjust a position of the chair seat 312 relative to the chair back 310 and thus relative to the support coupling structure 324 (i.e., portion of the coupling apparatus). It may be appreciated that such adjustment may be configured to provide a variable amount of traction to a user's spine. In other words, as the chair seat 312 is lowered, a relatively smaller portion of the user's weight may be supported by the supporting apparatus 308 while the user's upper body is coupled to the coupling structure 324, providing spinal decompression using gravity and the user's weight.

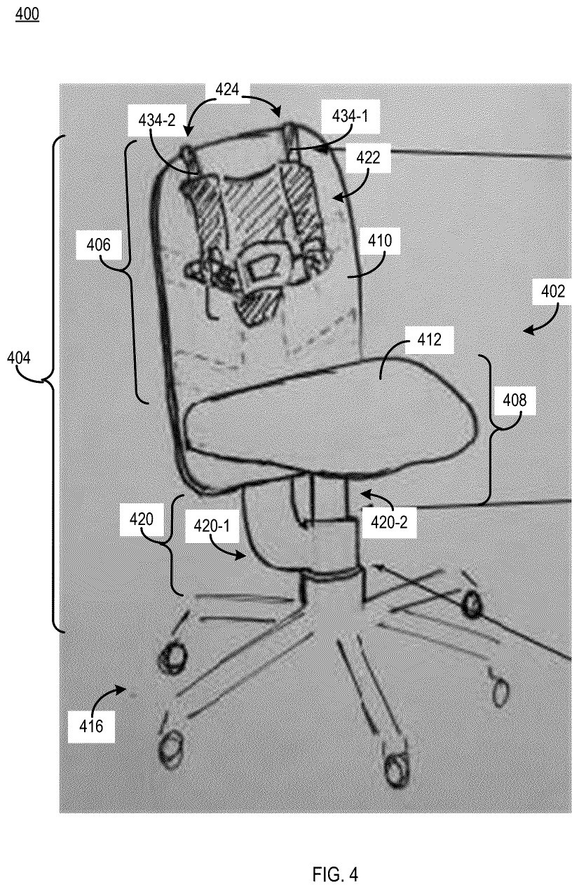

FIG. 4 is a sketch 400 illustrating an office chair 402 that includes another example system 404 for applying therapy to a human body, according to one embodiment of the present disclosure. The office chair 402 includes a chair back 410, a chair seat 412, a chair base 416, a seat and back height adjustment element (e.g., a pneumatic cylinder) 420-1, and a seat height adjustment element (e.g., a pneumatic cylinder) 420-2. The chair back 410 and chair seat 412 are coupled to the chair base 416 by the seat and back height adjustment element 420-1. The chair seat 412 is coupled to the chair back 410 by the seat height adjustment element 420-2.

The example therapy system 404 includes a coupling apparatus 406, a supporting apparatus 408, and a control apparatus 420 that includes the back height adjustment element 420-1 and the seat height adjustment element 420-2. The coupling apparatus 406 includes a user coupling structure 422, and a support coupling structure 424. The user coupling structure 422 generally corresponds to a harness assembly configured to encircle a torso of the user. The support coupling structure 424 is generally configured to be placed over the chair back 410 and may include one or more attachment features, e.g., straps 434-1, 434-2, configured to detachably couple the user coupling structure 422 to the support coupling structure 424 and/or the chair back 410.

In operation, the seat and back height adjustment element 420-1 is configured to adjust a position of the chair back 410 and chair seat 412 relative to the chair base 416, and the seat height adjustment element 420-2 is configured to adjust a position of the chair seat 412 relative to the chair back 410. Initially, the positions of the chair seat 412 and the chair back 410 relative to the chair base 416 may be adjusted to, for example, position the user relative to a work surface. The user may then attach to the support coupling structure 424 by putting on the user coupling structure, e.g., harness 422. The user may then adjust the position of the chair seat 412 relative to the chair back 410. Maintaining the position of the chair back 410 (and thus the position of the coupling apparatus 406) may facilitate maintaining the user position relative to the work surface and eliminate or reduce user repositioning relative to the work surface.

Adjusting the position of the chair seat 412 relative to the chair back 410 may operate to similarly adjust a position of the chair seat 412 relative to the coupling apparatus 406. It may be appreciated that such adjustment may be configured to provide a variable amount of traction to a user's spine. In other words, as the chair seat 412 is lowered, a relatively smaller portion of the user's weight may be supported by the supporting apparatus 408 while the user's upper body is coupled to the coupling structure 424, providing spinal decompression using gravity and the user's weight.

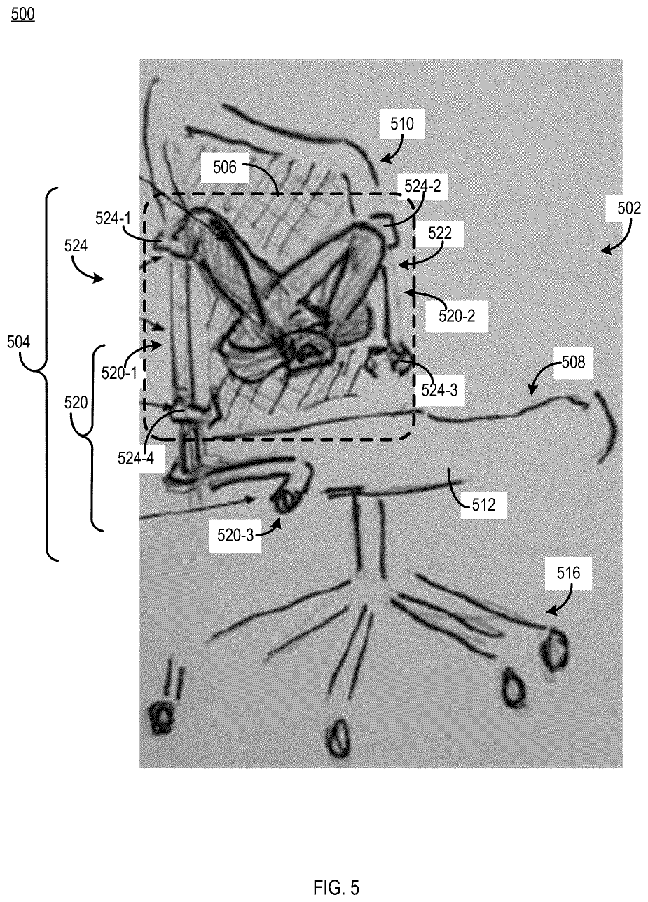

FIG. 5 is a sketch 500 illustrating an office chair 502 that includes another example system 504 for applying therapy to a human body, according to one embodiment of the present disclosure. The office chair 502 includes a chair back 510, a chair seat 512, a chair base 516, a plurality of mechanical actuators (e.g., a pneumatic cylinder) 520-1, 520-1 configured to adjust a coupling apparatus height, and a user input device (e.g., a lever) 520-3. The mechanical actuators 520-1, 520-2 and the user input device 520-3 may thus correspond to a control apparatus, as described herein.

The example therapy system 504 includes a coupling apparatus 506, a supporting apparatus 508, and a control apparatus 520 that includes the mechanical actuators 520-1, 520-2, and the user input device 520-3. The coupling apparatus 506 includes a user coupling structure 522, and a support coupling structure 524 that includes a plurality of support coupling structure elements, e.g., clamps 524-1, 524-2. The user coupling structure 522 generally corresponds to a harness assembly configured to encircle a torso of the user. The clamps 524-1, 524-2 are configured to attach the harness assembly to the mechanical actuators 520-1, 520-2 and the chair back 510.

In operation, the pneumatic cylinders 520-1, 520-2 are configured to adjust a position of the harness 522 relative to the chair seat 512. The user may adjust the position of the harness 522 relative to the chair seat 512 by moving the control lever 520-3.

Adjusting the position of the harness 522 relative to the chair seat 512 may operate to raise or lower the user relative to the chair seat 512. It may be appreciated that such adjustment may be configured to provide a variable amount of traction to a user's spine. In other words, as the harness 522 is raised, a relatively smaller portion of the user's weight may be supported by the supporting apparatus 508 while the user's upper body is coupled to the coupling structure 524, providing spinal decompression using gravity and the user's weight.

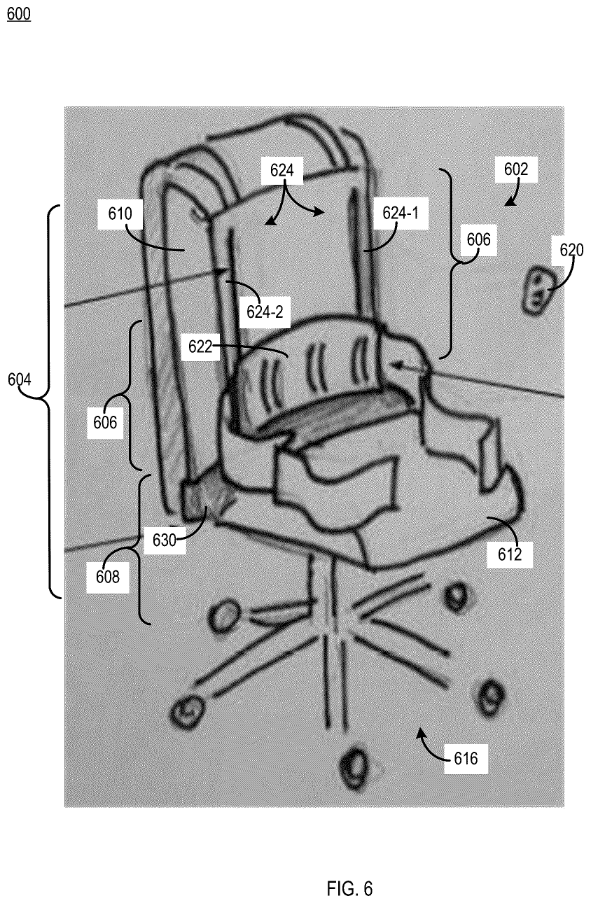

FIG. 6 is a sketch 600 illustrating an office chair 602 that includes another example system 604 for applying therapy to a human body, according to one embodiment of the present disclosure. The office chair 602 includes a chair back 610, a chair seat 612, and a chair base 616.

The example therapy system 604 includes a coupling apparatus 606, a supporting apparatus 608, and a control apparatus 620. The coupling apparatus 606 includes a user coupling structure 622, and a support coupling structure 624. The user coupling structure 622 generally corresponds to a belt configured to encircle a torso of the user. The support coupling structure 624 generally includes a plurality of rails positioned along a front surface of the chair back 610. The example therapy system 604 further includes a strap 630 configured to couple the user to the chair seat 612, i.e., the supporting apparatus 608.

In operation, a position of the belt 622 relative to the chair seat 612 may be adjusted by moving the belt 622 along the rails 624-1, 624-2. In one nonlimiting example, the rails may correspond to racks of rack and pinion assemblies and the pinions may be attached to shafts of electric motors that are then controlled by the remote controller 620. However, this disclosure is not limited in this regard. The user may thus adjust the position of the harness 622 relative to the chair seat 612 using the remote controller 620.

Adjusting the position of the belt 622 relative to the chair seat 612 may operate to increase or decrease a strain on the user's upper body relative to their lower body that may be coupled to the chair seat 612 by the hip strap 630. It may be appreciated that such adjustment may be configured to provide a variable amount of traction to a user's spine. In other words, as the belt 622 is raised and the user's lower body remains stationary, a relatively smaller portion of the user's weight may be supported by the supporting apparatus 608 while the user's upper body is coupled to the coupling structure 624, providing spinal decompression.

It may be appreciated that although the example chairs described above are office chairs, a system for applying therapy to a human body, according to the present disclosure, may be similarly implemented in other seating applications including, but not limited to, recliners, automotive seating, airline seating, etc., within the scope of the present disclosure.

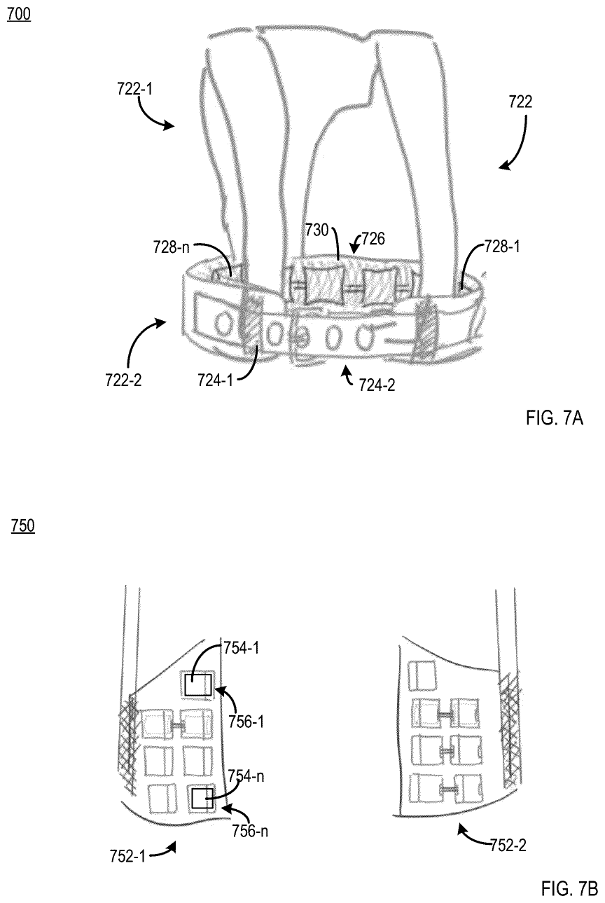

FIGS. 7A and 7B are sketches illustrating example adjustable features for enhancing user comfort for a coupling apparatus for a system for applying therapy to a human body, according to several embodiments of the present disclosure. FIG. 7A is a sketch 700 illustrating a vest 722 type user coupling structure, that may be configured to couple to a support coupling structure, as described herein. The example vest 722 includes a harness portion 722-1 and a belt portion 722-2. The belt portion 722-2 is configured with at least one adjustable attachment 724-1, 724-2. In some embodiments, a first adjustable attachment 724-1 may be configured to adjust a length of the harness portion 722-1 to accommodate a range of user torso heights. In some embodiments, a second adjustable attachment 724-2 may be configured to accommodate a range of user waist sizes.

An inner surface 726 of the belt portion 722-2 is configured to accommodate a plurality of pneumatic bladders 728-1, . . . , 728-n. The pneumatic bladders may be configured to conform the belt portion 722-1 to a shape of a user. The belt portion 722-1 may further include a compliant fabric layer 730 configured to cover the pneumatic bladders. The compliant fabric layer 730 may contain, for example, foam rubber. However, this disclosure is not limited in this regard. An inflation of the pneumatic bladders may be adjustable by the user, as described herein. Adjustable features may thus include, but are not limited to, adjustable attachments, pneumatic bladders, etc.

FIG. 7B is a sketch 750 illustrating a left front portion 752-1 and a right front portion 752-2 of a vest type user coupling structure, as described herein. Each front portion, e.g., left front portion 752-1, may include a plurality of pneumatic bladders 754-1, . . . , 754-n. The pneumatic bladders 754-1, . . . , 754-n may be configured to conform the vest type user coupling structure to a shape of a user. An inflation of the pneumatic bladders may be adjustable by the user, as described herein. The pneumatic bladders 754-1, . . . , 754-n may be enclosed in compliant pockets 756-1, . . . , 756-n. In some embodiments, individual pneumatic bladders may be removable.

Generally, this disclosure relates to a system for applying therapy to a human body (“therapy system”). Therapy may include, for example, spinal decompression. Spinal decompression is configured to relieve pressure on a spine of a user, and may include applying distractive tension. In some embodiments, the therapy may be applied while the user is in a sitting position, e.g., while sitting in a chair, and may be configured to apply a pulling force (i.e., tension). In some embodiments, the therapy may be applied while a user is at least partially suspended and may be configured to use gravity to apply the therapy.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. Logic and/or a module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 122 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system for applying therapy to a human body, the system comprising:
a coupling apparatus configured to couple to an upper body portion of a user; and
a supporting apparatus configured to support at least a portion of a weight of the user, wherein an amount of weight that is supported is adjustable.

2. The system of claim 1, further comprising a control apparatus configured to control at least one of a state and/or a position of the supporting apparatus.

3. The system of claim 1, wherein the coupling apparatus is selected from the group comprising a vest, a belt, a harness, one or more straps, a hook portion and/or a loop portion of a hook and loop assembly, and/or a combination thereof.

4. The system of claim 1, wherein the supporting apparatus is selected from the group comprising a chair, a chair back, a seat, a seat pan, a harness, and/or a combination thereof.

5. The system of claim 1, wherein the therapy is configured to be applied when the user is in a sitting position.

6. The system of claim 1, wherein the coupling apparatus and the supporting apparatus are configured to facilitate applying traction to at least a portion of a spine of the user.

7. The system of claim 1, wherein the supporting apparatus is configured to support a first portion of the weight of the user and the coupling apparatus is configured to support a second portion of the weight of the user.

8. The system of claim 1, wherein the coupling apparatus and the supporting apparatus are a same apparatus.

9. The system of claim 1, wherein the coupling apparatus comprises an adjustable feature configured to enhance user comfort.

10. The system of claim 2, wherein the control apparatus is further configured to control a state of the coupling apparatus.

11. A method for applying therapy to a human body, the method comprising:
coupling, by a coupling apparatus, to an upper body portion of a user; and
supporting, by a supporting apparatus, at least a portion of a weight of the user, wherein an amount of weight that is supported is adjustable.

12. The method of claim 11, further comprising controlling, by a control apparatus, at least one of a state and/or a position of the supporting apparatus.

13. The method of claim 11, wherein the coupling apparatus is selected from the group comprising a vest, a belt, a harness, one or more straps, a hook portion and/or a loop portion of a hook and loop assembly, and/or a combination thereof.

14. The method of claim 11, wherein the supporting apparatus is selected from the group comprising a chair, a chair back, a seat, a seat pan, a harness, and/or a combination thereof.

15. The method of claim 11, wherein the therapy is applied when the user is in a sitting position.

16. The method of claim 11, wherein the coupling apparatus and the supporting apparatus are configured to facilitate applying traction to at least a portion of a spine of the user.

17. The method of claim 11, wherein the supporting apparatus is configured to support a first portion of the weight of the user, and further comprising supporting, by the coupling apparatus, a second portion of the weight of the user.

18. The method of claim 11, wherein the coupling apparatus and the supporting apparatus are a same apparatus.

19. The method of claim 11, further comprising enhancing, by an adjustable feature, user comfort.

20. The method of claim 12, further comprising controlling, by the control apparatus, a state of the coupling apparatus.
